(19) United States
(12) Patent Application Publication
(10) Pub. No.: US 2012/0183182 A1
(43) Pub. Date: Jul. 19, 2012

(54) Integrated capture and analysis of documents

(76) Inventors: Pramod Kumar, Faridabad (IN); Virender Jeet, Noida (IN); Puja Lal, New Delhi (IN); Lal Chandra, Faridabad (IN); Raju Gupta, New Delhi (IN); Pallavi Jaiswal, Ghaziabad (IN); Mohd Amir, New Delhi (IN)

(21) Appl. No.: 13/374,822

(22) Filed: Jan. 17, 2012

(30) Foreign Application Priority Data
Jan. 14, 2011 (IN) 123/CHE/201

(51) Int. Cl. G06K 9/00

(52) U.S. Cl. 382/119; 382/100

(57) ABSTRACT

A system for integrated capture and analysis of documents comprising: an image capture unit configured to capture an image object of a document in real-time; a calibration unit coupled to the image capture unit configured to automatically calibrate capture parameters of the image capture unit and provide the captured image of the document; and an analysis unit coupled to the calibration unit configured to analyze quality of captured image of the document along with the validity of the document.

### RELATED APPLICATION

This is a utility patent application claiming priority from Indian Patent Application Serial Number 123/CHE/201, filed Jan. 14, 2011.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present disclosure relates to integrated capture and analysis of documents and more particularly, to integrated capture and analysis of documents in real-time by a cellular handheld device.

2. Background of the Invention

The use of mobile phones has been increasing rapidly from the past few years. Innovation in the mobile phones and its increasing demand has made this possible. The top-end phones presently available have the processing power and the memory capacity almost equal to that available in a personal computer a few years ago. These mobile phones have all the applications and the tools to replace bulky devices like a camera, a copier, a scanner etc. and it is also much handier for the user as compared to carrying these devices.

Mobile phones have already started functioning as much more than just a communication device. Mobile phones provide good quality cameras and a high storage capacity that have to a great extent reduced the use of digital devices like scanners, digital cameras as well.

With the increasing popularity of various personal electronic information and computing devices, such as mobile phones, there has been an increasing need to conveniently use the mobile phone for all the purposes that are currently solved through a personal computer and other similar devices. The use of mobile phones has thus been increasing over the past few years because of the flexibility to use it even when the user is on the move; for needs as diverse as capturing images and processing them, Internet Surfing, and much more. Business professionals have also shown a sharp increase in usage of mobile phones for their work. The freedom to do work anywhere and at any time through a mobile phone, ease of use and cost effectiveness has made a mobile phone an acceptable and useful tool in almost all the businesses. With the development and deployment of these wireless networking devices like the cell phones, personal digital assistant devices, etc. and infrastructures, consumers and businesses are increasingly being able to realize the benefits of true mobile computing and information exchange.

With the advent of technology and Internet, and the increased use of wireless devices, real-time electronic communication has become much easier. Innovation in the mobile phones and its increasing demand has also added on to its importance. Thus, mobile phones have already started functioning much more than just a communication device; a basic mobile phone these days provide good quality cameras varying from 2-5 MP. These phones are also inexpensive and within the reach of a common man.

In India, reaching distant and remote locations is a tedious job. Various basic facilities like obtaining a telephone/mobile connection, opening a bank account or taking a loan are still time intensive jobs in these areas due to the lack of basic resources and infrastructure. For instance, to get a new mobile connection, a user in the remote area submits an application form to an area-agent of the service provider. There are numerous agents located in different towns and villages for such activities. The Customer Application Forms or CAF's are also available with other kiosks in the areas. These agents collect the filled forms, along with the required documents, from the customer and send these to the area dealer. The area dealer then sends the documents to the processing centers in the nearby cities. The forms and various details are then verified at these processing centers and the mobile connection or service gets activated. This is thus a three-step long process and takes around 10-15 days as it involves physical movement of paper documents before the activation of the mobile service. Until then, the customer has to wait to get the connection. Another problem in such cases is the availability of the data capture devices. The forms are collected and batch of documents are then formed and sent to the nearest proximity center wherein the further processing takes place. This involves a lot of manual intervention as well. The huge devices installation, setup and maintenance are also not very cost-effective. Also, the quality of data capture happening at these centers is not guaranteed and in case of a document captured wrongly, the complete process has to be repeated again. After data capturing in proximity centers, data entry is done in the system.

In other instances of electricity supply or a Piped Natural Gas supply, a field staff visits the premises of the customer for manually noting down the meter reading. The staff then sends the details of the customer like the name, house number, meter number, etc. to the head office for bill generation. In the current scenario, there are problems like the handwriting of the staff is not readable from his register; there is no proof of the billed meter reading at a later stage. This causes disputes between the service provider and the customer; as the bill generated is generally an estimated bill depending upon the past usage record of the customer. The service provider has no proof of the reading taken that was captured manually for that particular period. The whole process of meter reading and bill generation takes approximately 4-5 days.

In an alternate embodiment, some service providers now provide a highly expensive device for an instant generation of a bill at the customer premise. However, the costs of these devices are much higher and not very financially feasible for the businesses. For customers residing in apartments, there is a centralized place where all the meters are placed. The staff generates the bill of all the apartments at once and then delivers them to their house. Thus, field staff also does the job of a postman that provides door-to-door bill delivery leading to a reduced efficiency of the staff as well.

### SUMMARY OF THE INVENTION

Embodiments of the present disclosure overcome solutions provided by the conventional art. The present invention relates to integrated capture and analysis of documents using a system for integrated capture and analysis of documents comprising an image capture unit configured to capture an image object of a document in real-time, a calibration unit coupled to the image capture unit configured to automatically calibrate capture parameters of the image capture unit and provide the captured image of the document and an analysis unit coupled to the calibration unit configured to analyze quality of captured image of the document along with the validity of the document.

The capture parameters of the image capture unit may comprise parameters such as distance of capture of an image object, ideal resolution for capture of an image object and area of coverage of the capture of an image object.

The analysis unit may be configured to analyze the quality of the captured image of the document based on features such as brightness, contrast, orientation, focus of capture, grainy image, spotlighting and too-dark or too-light images. Additionally, the analysis unit may be further configured to automatically enhance quality of the image object and detect defects in the image object requiring recapture of the document. According to yet another embodiment, the analysis unit may be configured to analyze the validity of the document by verifying photographs on documents, automatically verifying signatures on the document and automatic verification of image capture unit. It is also envisioned that the analysis unit may be further configured to intimate a user in real-time regarding validity of documents upon verification.

The present disclosure illustrate use of a cellular handheld device such as a mobile phone as the image capture unit but tablets and other handheld capture devices can be used. Also, according to certain embodiments of the present disclosure, the image capture unit is configured to capture an image object in any format such as JPEG, RAW and BMP.

A method is also disclosed for the integrated capture and analysis of documents which comprises capturing an image object of a document in real-time, calibrating automatically capture parameters of capture of an image object, providing the captured image of the document and analyzing quality of captured image of the document along with the validity of the document. The capture parameters of capture of an image document may be such as distance of capture of an image object, ideal resolution for capture of an image object and area of coverage of the capture of an image object. The present invention also incorporates analyzing quality of captured image of the document which would be based on features such as brightness, contrast, orientation, focus of capture and too-dark or too-light images. The method may further comprise automatically enhancing quality of the image object and detecting defects in the image object requiring recapture of the document. According to another embodiment of the present disclosure, analyzing the validity of the document may comprise verifying photographs on documents, automatically verifying signatures on the document and automatic verification of image capture unit.

The system for integrated capture and analysis of documents is realized by way of a cellular handheld device or other suitable devices and a backend server network where the cellular handheld device, i.e., a mobile phone is an integrated image capture unit and calibration unit while the backend server network is the analysis unit.

These and other objects, advantages, and novel features of the present invention will become apparent when considered with the teachings contained in the detailed disclosure which along with the accompanying drawings constitute a part of this specification and illustrate embodiments of the invention which together with the description serve to explain the principles of the invention.

### BRIEF DESCRIPTION OF THE DRAWINGS

The detailed description is described with reference to the accompanying figures. In the figures, a reference number identifies the figure in which the reference number first appears. The same numbers are used throughout the drawings to reference the same features and components.

FIG. 1 illustrates a system for integrated capture and analysis of documents of the present invention;

FIG. 2a illustrates examples of a common out of focus defect during capture of an image object;

FIG. 2b illustrates an example of a common out of focus grainy image defect during capture of an image object;

FIG. 2c illustrates an example of a common spotlight and trapezoid defect during capture of an image object;

FIG. 2d illustrates an example of common light and dark images during capture of an image object;

FIG. 3 illustrates a schematic for integrated capture and analysis of documents with a mobile phone;

FIG. 4 illustrates a flow chart for integrated capture and analysis of documents according to the present invention;

FIG. 5 illustrates a flow chart for integrated capture and analysis of documents according to an example of an embodiment of the present invention;

FIG. 6 illustrates a flow chart for analyzing quality and validity of captured image of the document according to the present invention; and

FIG. 7 illustrates a series of prospective views of mobile capture device used with the present invention.

### DESCRIPTION OF THE INVENTION

The following discussion provides a brief, general description of a suitable computing environment in which various embodiments of the present disclosure can be implemented. The aspects and embodiments are described in the general context of computer executable mechanisms such as routines executed by a general purpose computer, e. g., a server or personal computer. The embodiments described herein can be practiced with other system configurations, including Internet appliances, hand held devices, multi-processor systems, microprocessor based or programmable consumer electronics, network PCs, mini computers, mainframe computers and the like. The embodiments can be embodied in a special purpose computer or data processor that is specifically programmed configured or constructed to perform one or more of the computer executable mechanisms explained in detail below.

Exemplary embodiments are described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures. It should be appreciated that the functions, structures, elements and the protocols used in communication are not used in the present disclosure. Therefore, they need not be discussed in more detail here.

In addition, all logical units described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

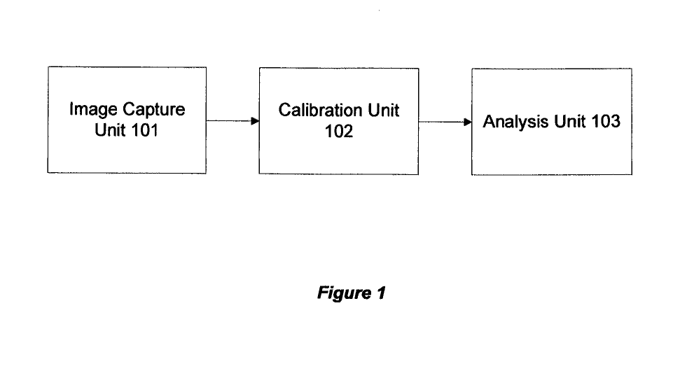

FIG. 1 illustrates a system for integrated capture and analysis of documents according to best mode and preferred embodiment of the present invention. The system comprises an image capture unit 101, a calibration unit 102 coupled to the image capture unit 101 and an analysis unit 103 coupled to the calibration unit 102. The image capture unit 101 is configured to capture an image object of a document in real-time. The calibration unit 102 is coupled to the image capture unit 101 to ensure that capture of an image object is appropriately done so. The calibration unit 102 is configured to automatically calibrate the capture parameters of the image capture unit 101 and provide the captured image of the document. The analysis unit 103 is coupled to the calibration unit 102 and is configured to analyze the quality of the captured image of the document as well as the validity of the document.

The system can work on devices like mobile phones, tablets and other handheld capture systems.

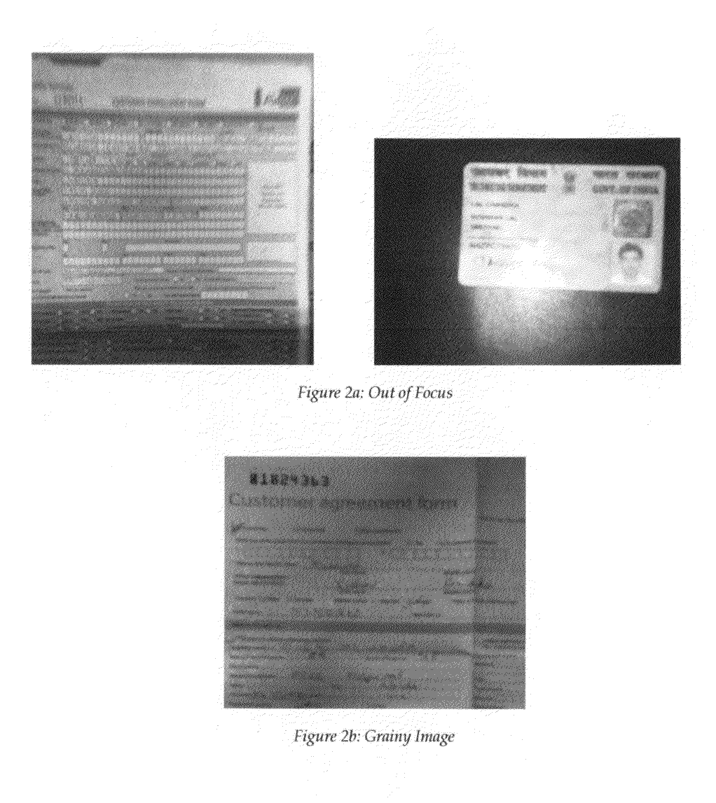

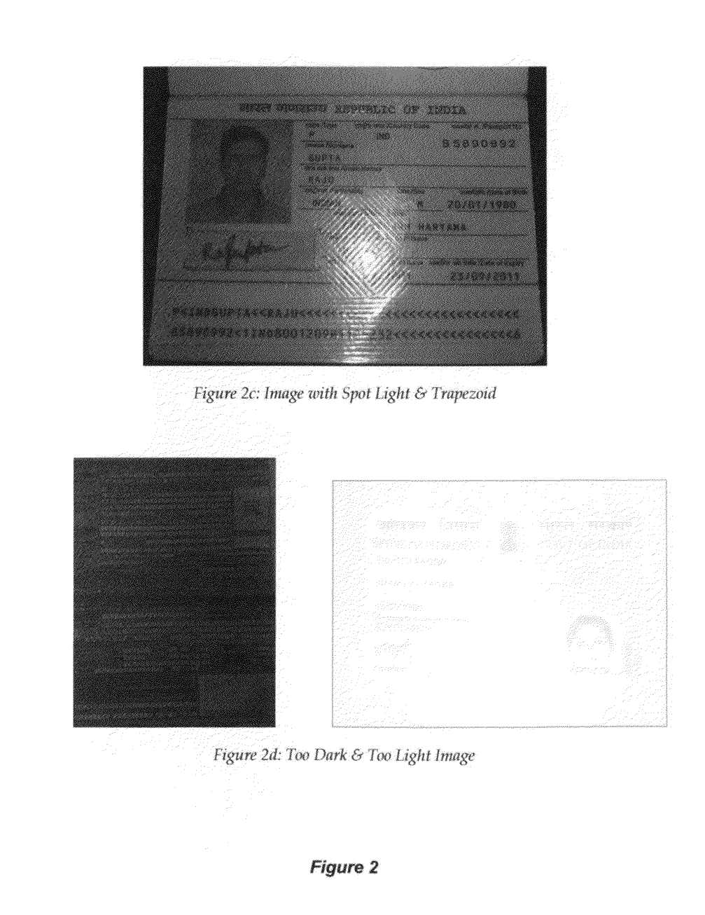

There are several defects that may occur during capture of an image of a document. These defects are illustrated in FIGS. 2a-2d. FIG. 2a illustrates image capture, which are out of focus, while FIG. 2b illustrates a grainy image capture of a document. FIG. 2c illustrates an image capture of document with spot light & trapezoid problem while FIG. 2d illustrates an image capture which is too dark and too-light. To overcome such defects, the calibration unit 102 is configured to calibrate several parameters of image capture. The capture parameters of the image capture unit 101 may comprise parameters such as distance of capture of an image object, ideal resolution for capture of an image object and area of coverage of the capture of an image object. The calibration unit 102 provides distance calibration for capturing images of different documents.

Distance calibration is performed for height at which the image is captured. The height at which the image is captured is dependent on the type of document that is being captured. The calibration unit 102 determines the size and type of document such as PAN card, passport and bank loan forms and anchors the height at which the image capture shall be of good quality.

The calibration unit 102 is configured to determine the ideal resolution at which the image should be captured. The resolution may be calculated by the calibration unit 102 based on the size of the document as well the distance of the image capture. The capture parameters may be set for automatic capture of a set/batch of documents.

The calibration unit 102 is configured to calibrate capture parameters such as area of coverage of the capture of an image object. The area of coverage of the capture of an image object relates to truncated image capture and cropped image capture. A flag is raised if the captured image of the document is truncated. A histogram analysis may be performed to detect the captured corner/edges and the level of truncation. In the event the captured image is truncated, the calibration unit 102 is configured to alert the user for re-capture of the document.

The analysis unit 103 is configured to analyze the quality of the captured image of the document based on features such as brightness, contrast, orientation, focus of capture and too-dark or too-light images. The analysis unit is further configured to automatically enhance quality of the image object and detect defects in the image object requiring recapture of the document. The defects in capture of an image of a document have been illustrated previously in FIGS. 2a-d. The analysis unit 103 is configured to enhance image quality by automatically optimizing the brightness and contrast, reducing noise in the captured image and correcting perspective view of the captured image. The analysis unit 103 additionally enhances the quality of the captured image by optimizing the skew, orientation and cropping. In case the defects cannot be enhanced such when the image is out of focus, blurred image, truncated content at edges, spot light images and too-dark or too-light images, the analysis unit 103 alerts the user regarding the requirement of recapture of image of the document.

The analysis unit 103 is configured to analyze the validity of the document by verifying photographs on documents, automatically verifying signatures on the document and automatic verification of image capture unit. Upon verification, the analysis unit 103 is configured to alert the user regarding validity of documents in real-time. An example of such embodiments of the present disclosure is illustrated further in the specification.

The analysis unit 103 is configured to identify whether the captured image is of an original document or a photocopy of the document. Such identification by the analysis unit 103 is enabled through color quotient. The identification of the type of document ensures that quality of capture of image is maintained and that there is no discrepancy in the same.

Other operations that are performed at device level are:
a. Region-wise binarization of an image.
Adaptive binarization for photographs for maintaining good quality
Local window binarization for rest of the form.
b. G4 compressed tiff generation enabling multipage document (caf, supporting docs, etc.) packing in one file with good compression.
c. Automatic photograph cropping from application form image using face detection. Co-ordinate base cropping also supported.
d. Captured document Image quality enhancement for increasing OCRability

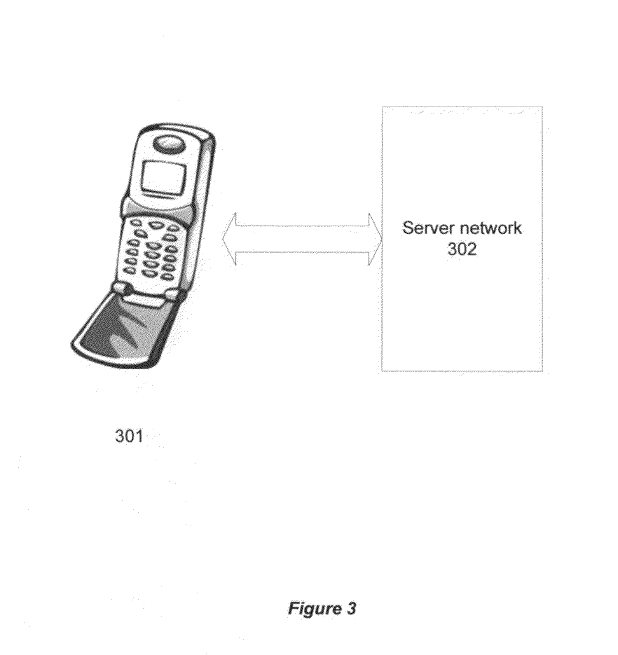

FIG. 3 illustrates a system for integrated capture and analysis of documents. The figure discloses implementation of the embodiment disclosed in FIG. 1 by way of a cellular handheld device 301 and a backend server network 302. The mobile phone 301 is registered with the service provider of the backend server network. The mobile phone 301 is configured to capture images of documents according to an inbuilt calibration mechanism and forward the captured image of the document to the backend server network 302. The server network 302 is configured to analyze the quality of the captured image of the document and enhance the same for verification of validity. If the captured image of the document is suitable, the backend server network 302 continues with the verification of validity of the document. The backend server network 302 validates the captured image of the document by automated photo matching, automated signature verification and verification of the retailer's registered mobile. Examples of such verification are such as photo matching for matching the photos on a POA (Power of Attorney), POI with the cross-signed photograph submitted by the customer, automated signature verification for matching the signatures of the customer. Additional examples are such as automatic verification of mobile phone registered with service provider of the backend server network.

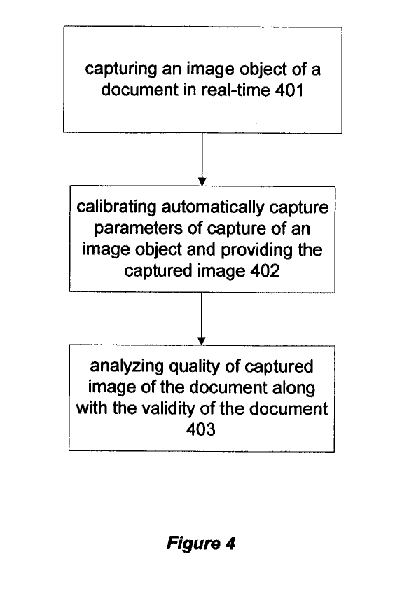

Embodiments of the method for integrated capture and analysis of documents are described in FIGS. 4 to 6 of the present disclosure. The methods are illustrated as a collection of blocks in a logical flow graph, which represents a sequence of operations that can be implemented in hardware, software, or a combination thereof. The order in which the process is described is not intended to be construed as a limitation, and any number of the described blocks can be combined in any order to implement the process, or an alternate process.

FIG. 4 illustrates a method for integrated capture and analysis of documents. The method comprises the steps of capturing an image object of a document in real-time 401 by calibrating automatically capture parameters of capture of an image object 402 and analyzing quality of captured image of the document along with the validity of the document 403. The method further comprises automatically enhancing quality of the image object and detecting defects in the image object requiring recapture of the document. The present invention analyzes the validity of the document by verifying photographs on documents, automatically verifying signatures on the document and automatic verification of image capture unit. Upon verification of the document, the user is informed regarding the validity of documents in real-time.

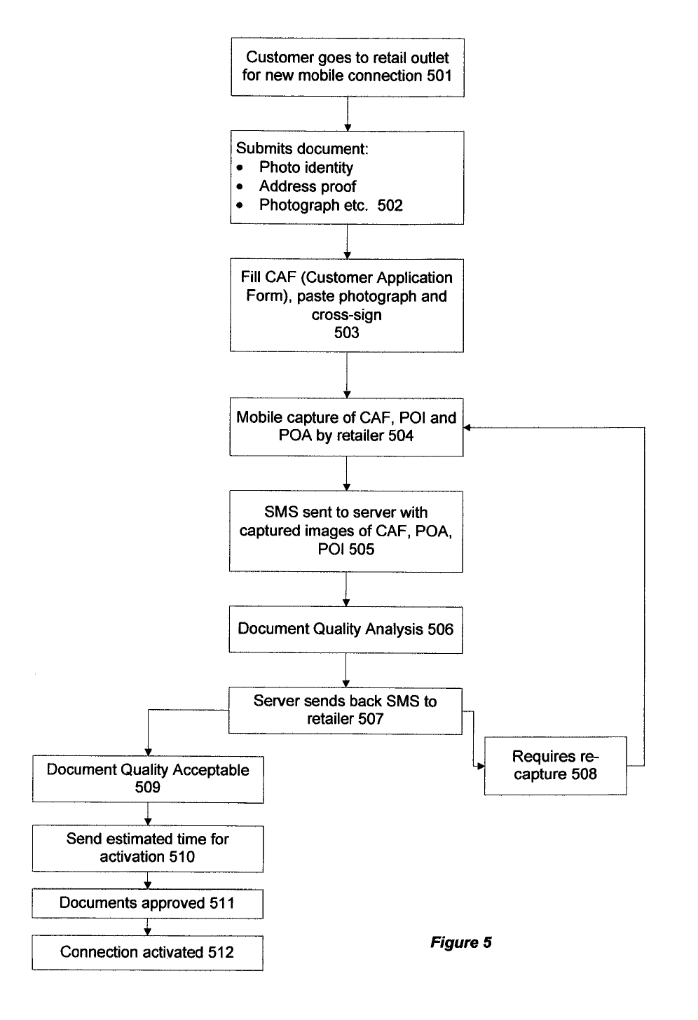

FIG. 5 illustrates a method for integrated capture and analysis of documents according to the present invention. According to the example, a customer in a remote location walks into a kiosk/retail outlet 501 for getting new mobile connection. The customer provides necessary documents 502 such as photographs, POA and POI while the registered retailer fills a CAF (Customer Application Form) 503 with the details as per submitted documents. Upon due filling of the form, the retailer captures an optimized image of each document 504 and forwards the same to the server network of a service provider 505. The retailer additionally provides CAF number by entering the number through the keypad. The server network then analyzes the documents 506 and sends a message to the retailer via an SMS 507 regarding the quality of the captured image of the documents. The server network then informs the retailer whether recapture of documents is required 508 or if the quality of the image of the documents is acceptable 509. The server network may additionally send estimated time for activation of service to the mobile connection 510. Once, the documents are approved 511, the connection is activated 512.

The system can work in the following ways:
a. The documents are captured through a capturing device and DQA (Documents Quality Analysis) operations can be performed at the server-end.
b. The documents are captured through a capturing device and all operations performed on the device itself (mDQA or Mobile Document Quality Analysis).
c. The documents are captured through a capturing device and operations are performed both at server level and device level.

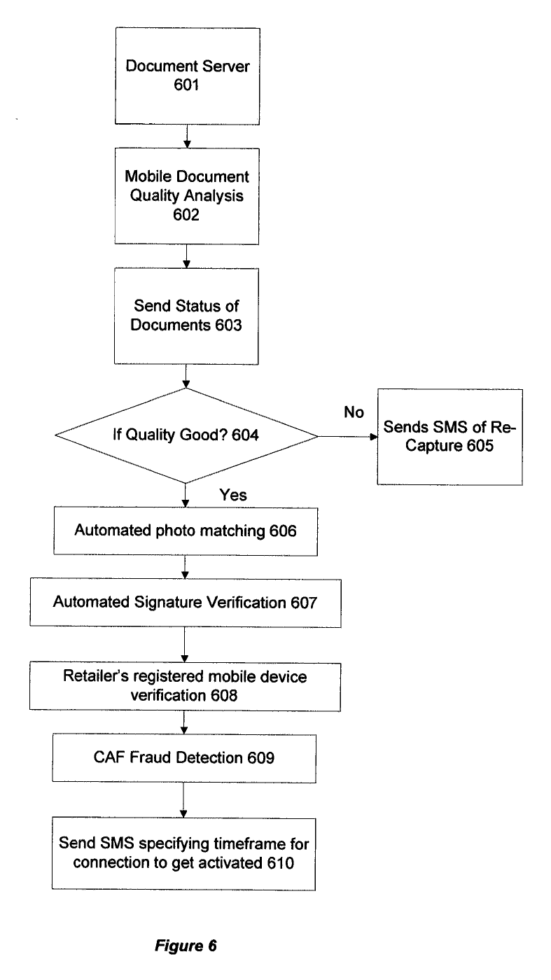

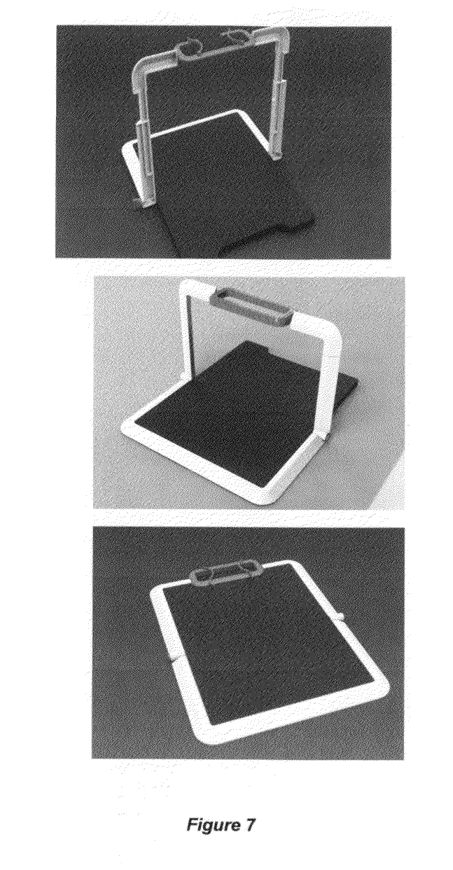

FIG. 6 illustrates in detail the method for analyzing quality and validity of captured image of the document. According to the example, the server network comprises a database with reference documents and is therefore, also referred to as a document server 601. The server receives captured images of the documents and performs a quality analysis on the same 602. This may be referred to as Mobile Document Quality Analysis (mDQA). The document image is then, checked for various errors such as Out of focus, blur image, truncated content and grainy image and forwards the status of the images of the documents to the customer 603. If the quality of the images of the documents is good 604, a security check is performed. If not, the server network forwards an SMS to the customer to recapture the images of the documents 605. The security check performed comprises automatic photo matching 606 for matching the photos on POA, POI with the cross-signed photograph submitted by the customer, automatic signature verification 607 for matching the signatures of the customer and automatic verification of retailer's registered mobile 608 with the registered details previously stored in the database. CAF fraud detection 609 is also done by checking the CAF number against valid CAF number database and dealer/retailer to whom the form was issued. Additionally, since the retailer has already punched in the CAF number through his keypad, it easier to detect CAF fraud. Once the security check is complete, the server network intimates the customer regarding the time required to activate the mobile connection 610.

FIG. 7 illustrates a mobile capture device. It refers to a customized capture device with a slot for fitting the mobile phone.

The present invention provides an economic and hassle-free solution. In instances of bill generation such as in case of an electricity supply or a Piped Natural Gas supply, a field staff visits the premises of the customer for manually entering the meter reading. The staff then sends the details of the customer such as name, house number and meter number to the head office for bill generation. Conventionally, when there are issues such as the handwriting of the staff is not readable from his register, there is no proof of the billed meter reading at a later stage. Disputes are therefore, likely to arise between the service provider and the customer; as the bill generated is generally an estimated bill depending upon the past usage record of the customer. The service provider has no proof of the reading taken that was captured manually for that particular period. The whole process of meter reading and bill generation takes an approximate 4-5 days. Some service providers provide a highly expensive handy device for an instant generation of a bill at the customer premise However, the costs of these devices are high and they are not financially feasible. For customers residing in apartments, there is a centralized place where all the meters are placed. The staff generates the bill of all the apartments at once and then delivers them to their house. Thus, field staff also does the job of a postman that provides bill door-to-door delivery leading to a reduced efficiency of the staff as well. The present invention ensures that the customer feels completely satisfied with the services being offered as there is complete transparency in the process. The cost of implementation is also drastically reduced as it does not require any additional device or system and a mobile phone is already a part of our daily lives.

As regard the businesses, it leads to quick collection of revenues as there won't be any customer or internal issues regarding the process of bill generation. Also, the efficiency of the process is increased due to reduced human-error. The cost of maintenance is highly reduced as timely maintenance of equipments and instant detection of faulty devices is immediately detected.

As will be appreciated by one of skill in the art, the present invention may be embodied as a method, system, or computer program product. Accordingly, the present invention may take the form of an entirely hardware embodiment, a software embodiment or an embodiment combining software and hardware aspects all generally referred to herein as a “circuit” or “module. ” Furthermore, the present invention may take the form of a computer program product on a computer-usable storage medium having computer-usable program code embodied in the medium.

Furthermore, the present invention was described in part above with reference to flowchart illustrations and/or block diagrams of methods, apparatus (systems), and computer program products according to embodiments of the invention.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 4-6 illustrate the architecture, functionality, and operations of methods, systems, and computer program products for integrated capture and analysis of documents. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A system for integrated capture and analysis of documents comprising:
an image capture unit configured to capture an image object of a document in real-time;
a calibration unit coupled to the image capture unit configured to automatically calibrate capture parameters of the image capture unit and provide the captured image of the document; and
an analysis unit coupled to the calibration unit configured to analyze quality of captured image of the document along with the validity of the document.

2. A system as claimed in claim 1 wherein the capture parameters of the image capture unit comprise parameters such as distance of capture of an image object, ideal resolution for capture of an image object and area of coverage of the capture of an image object.

3. A system as claimed in claim 1 wherein the analysis unit is configured to analyze the quality of the captured image of the document based on features such as brightness, contrast, orientation, focus of capture and too-dark or too-light images.

4. A system as claimed in claim 1 wherein the analysis unit is further configured to automatically enhance quality of the image object and detect defects in the image object requiring recapture of the document.

5. A system as claimed in claim 1 wherein the analysis unit is configured to analyze the validity of the document by verifying photographs on documents, automatically verifying signatures on the document and automatic verification of image capture unit.

6. A system as claimed in claim 5 wherein the analysis unit is further configured to intimate a user in real-time regarding validity of documents upon verification.

7. A system as claimed in claim 1 wherein the image capture unit is a cellular handheld device such as a mobile phone.

8. A system as claimed in claim 1 wherein the image capture unit is configured to capture an image object in any format such as JPEG, RAW and BMP.

9. A method for integrated capture and analysis of documents comprising:
capturing an image object of a document in real-time;
calibrating automatically capture parameters of capture of an image object and providing the captured image of the document; and
analyzing quality of captured image of the document along with the validity of the document.

10. A method as claimed in claim 9 wherein the capture parameters are such as distance of capture of an image object, ideal resolution for capture of an image object and area of coverage of the capture of an image object.

11. A method as claimed in claim 9 wherein analyzing quality of captured image of the document is based on features such as brightness, contrast, orientation, focus of capture and too-dark or too-light images.

12. A method as claimed in claim 9 wherein the method further comprises automatically enhancing quality of the image object and detecting defects in the image object requiring recapture of the document.

13. A method as claimed in claim 9 wherein analyzing the validity of the document comprises verifying photographs on documents, automatically verifying signatures on the document and automatic verification of image capture unit.

14. A method as claimed in claim 13 wherein the method further comprises intimating a user in real-time regarding validity of documents upon verification.

15. A method as claimed in claim 9 wherein the image object is captured in any format such as JPEG, RAW and BMP.

16. A system as claimed in claim 1 wherein said the analysis unit has image quality enhancement for increasing OCR ability.

17. A system as claimed in claim 4 wherein said the analysis unit has automatic photograph cropping using face detection.

18. A system as claimed in claim 4 wherein said analysis unit is provided with region-wise binarization of an image.

19. A system as claimed in claim 4 wherein said analysis unit has G4 compressed tiff generation enabling multipage documents packing in one file with compression.

20. A system as claimed in claim 18 wherein said region-wise binarization has adaptive binarization for photographs.

21. A system as claimed in claims 18 wherein said region-wise binarization additionally has local window bi for the rest of a form bearing said image.
